(19) United States
(12) Patent Application Publication
(10) Pub. No.: US 2024/0020740 A1
(43) Pub. Date: Jan. 18, 2024

(54) REAL-TIME RADIOLOGY REPORT COMPLETENESS CHECK AND FEEDBACK GENERATION FOR BILLING PURPOSES BASED ON MULTI-MODALITY DEEP LEARNING

(71) Applicant: KONINKLIJKE PHILIPS N.V., Eindhoven (NL)

(72) Inventors: Saifeng LIU, CAMBRIDGE, MA (US); Xin WANG, BELMONT, MA (US); Yuechen QIAN, LEXINGTON, MA (US); Thusitha Dananjaya De Silva MABOTUWANA, REDMOND, WA (US); Jesse WAKLEY, CAMBRIDGE, MA (US)

(21) Appl. No.: 18/221,929

(22) Filed: Jul. 14, 2023

Related U.S. Application Data
(60) Provisional application No. 63/389,152, filed on Jul. 14, 2022.

(51) Int. Cl. G06Q 30/04

(52) U.S. Cl. CPC G06Q 30/04

(57) ABSTRACT

A radiology workstation includes at least one display device, at least one user input device, and an processor configured to: provide a radiology examination reading environment configured to display images of a radiology examination on the at least one display device, receive a radiology report for the radiology examination which is entered using the at least one user input device; analyze the radiology report to predict one or more billing codes for the radiology examination; analyze the radiology report to identify any missing content for supporting the one or more billing codes that is missing from the radiology report; and one of (i) in response to identifying missing content, display an indication of the missing content, or (ii) in response to not identifying any missing content, storing the radiology report in a database.

### CROSS REFERENCE TO RELATED APPLICATION

This application claims the benefit of U.S. Provisional Patent Application Ser. No. 63/389,152, filed Jul. 14, 2022. This application is incorporated by reference herein.

### FIELD

The following relates generally to the medical imaging arts, radiology arts, radiology reading arts, radiology workstation arts, workstation user interfacing arts, medical coding arts, and related arts.

### BACKGROUND

Medical coding is the process of assigning billing code for creating insurance claims, based on medical records and clinical documentation (i.e., radiology reports). Two commonly used types of codes for billing purposes are: diagnosis codes (ICD-10) and procedure codes (Current Procedural Terminology (CPT) and Healthcare Common Procedure Coding System (HCPCS)). While the diagnosis codes explain why the patient sought medical services, the procedure codes describe the services provided to the patient. Billing codes are typically assigned by a trained coder with assistance of medical coding software. Accurate billing code assignment is critical, since any coding errors may lead to denied payments, revenue loss and decreased efficiency of providers, and stress and potentially unnecessary financial burden for patients. Billing code errors can be caused by incomplete clinical documentation or medical records, and/or errors made by the coder during the coding process. Thus, it is important to detect and correct any billing code errors during report writing or coding.

In a typical medical institution workflow, a clinician such as a doctor, radiologist, or the like prepares a medical report on a procedure, examination, imaging session, or so forth. The medical report is a clinical document, but also serves as the basis for assigning billing codes to the procedure for billing purposes. The clinician is trained to write the medical report for the former task of providing an actionable clinical document, but the clinician may be less aware of, and/or less well trained as to, the requirements of the medical report for billing purposes. Hence, the clinician may omit or poorly phrase information in the medical report that is important for accurately assigning billing codes. This can lead to downstream coding errors as the trained coder is unable to determine appropriate billing codes based on the medical report.

The following discloses certain improvements to overcome these problems and others.

### SUMMARY

In some embodiments disclosed herein, a radiology workstation includes at least one display device, at least one user input device, and a processor configured to: provide a radiology examination reading environment configured to display images of a radiology examination on the at least one display device, receive a radiology report for the radiology examination which is entered using the at least one user input device; analyze the radiology report to predict one or more billing codes for the radiology examination; analyze the radiology report to identify any missing content for supporting the one or more billing codes that is missing from the radiology report using an artificial intelligence (AI) component; responsive to identifying more than one billing codes from the radiology reports, ranking such missing billing codes based on a probability; and one of (i) in response to identifying missing content, display an indication of the missing content, or (ii) in response to not identifying any missing content, storing the radiology report in a database.

In some embodiments disclosed herein, a non-transitory computer readable medium stores instruction executable by at least one processor to perform a radiology examination reading support method. The method includes: displaying images of a radiology examination on at least one display device; receiving a radiology report for the radiology examination which is entered using at least one user input device; predicting one or more billing codes for the radiology examination; predicting missing content of the radiology report for supporting the one or more billing codes that is missing from the radiology report using an artificial intelligence (AI) component; ranking such missing billing codes based on a probability, and one of (i) in response to identifying missing content displaying, on the at least one display device, the missing content based on the ranking as a suggested addition to the radiology report or (ii) in response to not identifying any missing content, storing the radiology report in a database.

In some embodiments as set forth in the immediately preceding paragraph, the radiology examination reading support method further includes: transmitting the images of the radiology examination from a hospital to a teleradiology service via the Internet, wherein the displaying of the images on the at least one display device includes displaying the images on at least one display device located at the teleradiology service and the radiology report is entered using the at least one user input device located at the teleradiology service; and transmitting the radiology report from the teleradiology service to the hospital via the Internet.

In some embodiments disclosed herein, a non-transitory computer readable medium storing instruction executable by at least one processor to perform a radiology examination reading support method. The method includes: displaying images of a radiology examination on at least one display device; receiving a radiology report for the radiology examination which is entered using at least one user input device; predicting one or more billing codes for the radiology examination; predicting missing content of the radiology report for supporting the one or more billing codes that is missing from the radiology report using an artificial intelligence (AI) component; and scoring the radiology report as to a degree of completeness of the radiology report.

In some embodiments disclosed herein, In some embodiments disclosed herein, a method for supporting radiology examination reports reading is proposed. The method comprising displaying images of a radiology examination on at least one display device; receiving a radiology report for the radiology examination which is entered using at least one user input device; predicting one or more billing codes for the radiology examination; predicting missing content of the radiology report for supporting the one or more billing codes that is missing from the radiology report using an artificial intelligence component; ranking such missing billing codes based on a probability, and one of (i) in response to identifying missing content, displaying, on the at least one display device, the missing content based on the ranking as a suggested addition to the radiology report or (ii) in response to not identifying any missing content, storing the radiology report in a database.

In some embodiments disclosed herein, a method of training an artificial intelligence component configured to predict missing content of a radiology report is proposed. The method comprising the steps of obtaining, from a first memory, a first dataset comprising a plurality of radiology reports, the plurality of radiology reports being labelled with billing codes, wherein the plurality of radiology reports are complete in their content for supporting one or more billing codes; obtaining, from a second memory, a second dataset comprising metadata associated with the plurality of the radiology reports; converting the obtained first datasets and second datasets into feature vectors; updating the artificial intelligence (AI) component using the feature vectors; providing the artificial intelligence (AI) component with additional radiology reports, wherein the additional radiology reports are either complete or incomplete in their content for supporting one or more billing codes; and outputting information as to whether missing content of the radiology report for supporting the one or more billing codes is present.

One advantage resides in reducing billing code errors for medical procedures.

Another advantage resides in providing a clinician with guidance when drafting a medical report on a medical procedure or service to ensure the medical report contains the information needed to properly assign billing codes for the medical procedure or service.

Another advantage resides in collecting feedback from a medical professional to reduce billing code errors for medical procedures.

Another advantage resides in using artificial intelligence to reduce billing code errors for medical procedures.

Another advantage resides in providing a radiology reading environment to show both images and a radiology report, and also allows a medical professional to select billing codes for a medical procedure encompassing the images and radiology report.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically illustrates a radiology workstation in accordance with the present disclosure.

FIG. 2 diagrammatically illustrates a method using the radiology workstation of FIG. 1.

FIG. 3a shows an example of an artificial intelligence (AI) component implemented in the radiology workstation of FIG. 1.

FIG. 3b shows an example of an artificial intelligence (AI) component implemented in the radiology workstation of FIG. 1.

FIG. 4 shows a report correction generator implemented in the radiology workstation of FIG. 1.

### DETAILED DESCRIPTION

The present disclosure describes various embodiments of a system and method configured to detect whether a radiology report is complete for further processing for coding process, and to automatically generate missing content suggestion, in case determine as incomplete. More generally, inventors have recognized and appreciated that it would be beneficial to provide an intelligent data-driven revision mechanism of radiology report such as to improve radiology workflow and better support physicians' efficiency.

In a typical radiology workflow, a radiologist reads a radiology examination and prepares a radiology report. To bill the examination to a medical insurance company, the radiology report is associated to one or more medical procedure codes of a standardized coding scheme such as Current Procedural Terminology (CPT) or Healthcare Common Procedure Coding Scheme (HCPCS). Due to the complexity of the coding process, it is usually handled, not by the radiologist, but rather by a dedicated coding department or contracted third-party staffed by so called “coders” with certification in the coding process.

However, the coder can only work with the material provided. Notably, if the radiology report is “incomplete” in that it does not document a radiology examination or procedure in language that maps to the CPT, HCPCS, or other coding standard, then the coder will be unable to bill the work correctly, leading to delays or denial of payment. The language used by the radiologist may be complete in terms of providing a fully actionable radiology report for use by the patient's doctor or other clinicians, and yet be “incomplete” as regarding its usability for assigning billing codes for the radiology examination or procedure. As recognized herein, this problem can occur frequently, because the radiologist is trained to provide a clinically actionable radiology report, but is not necessarily trained to choose language and description that facilitates assigning accurate billing codes, since that task is usually not performed by the radiologist but rather by a trained coder.

To address this difficulty, the following discloses adding a sub-system to the radiology workstation, or in communication with the radiology workstation, which is configured to analyze completeness of a radiology report for billing purposes, and works with the radiologist to correct any incomplete report.

This sub-system comprises one or more models configured to classify the report as to predicted billing codes and report completeness. Contemplated model(s) hereunder can include or consists of rule-based modeling, machine learning (ML), deep learning (DL), neural network (NN), language model (LM), or any combination thereof. Additionally or concurrently, models in accordance with this disclosure could comprise or consist of Rule-based machine learning (RBML). Language models could, for example, be implemented using the Bidirectional Encoder Representations from Transformers (BERT) language model. Machine learning models could include, for instance, a convolutional neural network (CNN).

Alternatively, analysis can take the form of rule-based modeling, where the rule-set can either be translated into a model such as Markov chains or differential equations, or be treated using tools that directly work on the rule-set in place of a translated mode. Such model is based on probabilistic rules.

Within this document, the term Artificial Intelligence (AI) will be used as encompassing any model capable, when configured or trained, to predict, automated and optimize one or more tasks, which model can be or include, amongst others, machine learning (ML), deep learning (DL), neural network (NN), language model (LM).

Any AI based model needs to be pre-trained, i.e., to undergo a training phase prior to the deployment phase. Such training phase (supervised or unsupervised) includes a plurality of data points in the form of dataset. The training data include, amongst others radiology reports associated with, or labelled with, billing code(s). These radiology reports will comprise the report, generally in a text format, and the image(s). In addition, the training data may be labelled or un-labelled, and/or include metadata associated with each radiology reports, wherein such metadata can include, for instance, information on the patient associated with said radiology report (e.g., sex, age, condition, etc.), on the date of the examination, the manufacturing of the imaging equipment, the healthcare institution, etc. The training data may be stored in and/or received from one or more databases or memories. The database may be a local and/or remote database.

Once the training phase completed, the AI model can be deployed in one or more sub-system. In the deployment phase, a radiology report is inputted to the sub-system which includes the trained model(s). The model according to the present disclosure will, be ran or reviewed by one or more models, which may be AI based. The output of such model(s), which preferably occur in real time, could be classification of the report as complete, or incomplete (in full or in part).

If a report is classified as incomplete, then the radiologist is presented with the predicted billing codes (for example, a top-K most likely billing codes as determined by the AI). The AI then runs the radiologist-selected billing code (or codes) through a reverse transformer layer to predict report content that would support the selected billing code(s). This predicted content is presented as proposed revisions to the radiologist (possibly in parameterized form) on a user interface, which may be the same user interface used by the radiologist in drafting the report. The radiologist can accept, reject, or modify the proposed revisions. This then generates a corrected report, which is then again run through the AI component to predict updated billing code(s) and report completeness. Such a process can be repeated multiple times until the AI outputs an indication that the report is complete in terms of being codable. Advantageously, this ensures that the radiologist generates a radiology report that is suitable for supporting the billing codes assignment task, as well as being a clinically actionable radiology report.

In some embodiments, the disclosed improvements are implemented as a sub-system that is integrated with the radiology workstation. The purpose of the disclosed sub-system is to assist the radiologist so as to ensure the final radiology report is codable in the subsequent coding phase. Hence, an improved radiology workstation is also disclosed.

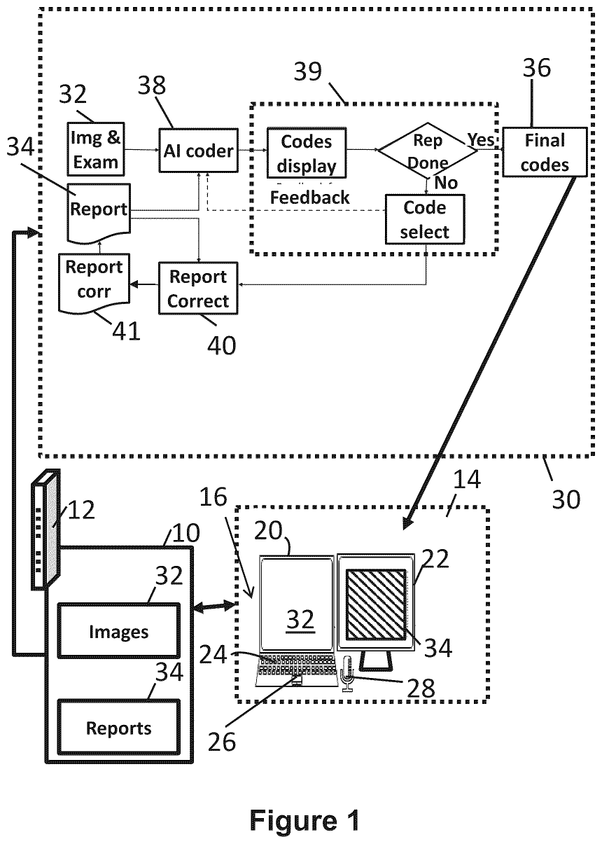

With reference to FIG. 1, a Picture Archiving and Communication System (PACS) 10 is implemented on a networked computing system 12 diagrammatically indicated in FIG. 1 by a server computer. It will be appreciated that the networked computing system 12 may comprise a single server computer, a computing cluster, a cloud computing resource, or so forth. The PACS 10 installed on the networked computing system 12 is connected with one or (more typically) a plurality of radiology workstations, where FIG. 1 illustrates a single representative radiology workstation 14, via a secure electronic data network, such as a wired and/or wireless Wide Area Network (WAN) implemented via Ethernet, Wi-Fi, or another suitable wired and/or wireless electronic data networking protocol. In some implementations employing a teleradiology service, some or all of the radiology workstations 14 could be located at a third party, such as a teleradiology service provider that provides radiology readings to the hospital as a contracted service. For example, the images may be acquired at the hospital using a hospital medical imaging device, and these images and associated data (e.g., patient medical data) are then sent to the teleradiology service which employs radiologists that perform readings of such received imaging examinations as a service, with the resulting radiology report being sent to the hospital. In such implementations, the secure electronic data network may include the Internet. The PACS 10 may also be implemented as two IT systems—a hospital PACS and a teleradiology service PACS, and the images may then be transferred between the two PACS. The secure electronic data network should have sufficient bandwidth to communicate radiology images, which are typically large data files, to and from the radiology workstation 14. Optionally, the PACS 10 installed on the networked computing system 12 may be connected with other computing systems such as physician's desktop computers, radiological imaging system controllers (e.g., MRI or CT system controllers) or so forth (not shown). The PACS 10 serves various information technology (IT) functions as relates to radiology, such as providing a repository for storing radiology examinations including radiology images which are commonly stored in a DICOM format, along with a graphical user interface via which a user can retrieve, view, and manipulate such images, prepare and store a corresponding radiology report, and so forth. The PACS 10 may be otherwise named depending on the specific commercial implementation.

Each radiology workstation 14 includes a processor (electronic processor), for example embodied as a computer 16 (or alternatively e.g., a cellular telephone (“cell phone”), a smart tablet, and so forth) comprising at least one electronic processor. Each radiology workstation 14 further includes at least one display device, e.g., an illustrative display device 20 of the computer 16 and an additional display device 22 (e.g., an LCD display, plasma display, cathode ray tube display, and/or so forth). This display device(s) 20 or 22 may include a browser. Providing the radiology workstation 14 with two (or more) display devices 20, 22 can be advantageous as it allows one display device 20 to be used to display textual content or other auxiliary information while the other display device 22 is used as a dedicated radiology image viewer; however, a radiology workstation 14 with only a single display device is also contemplated. At least one display device 20, 22 of the radiology workstation 14 should be a high-resolution display capable of displaying radiology images with sufficiently high resolution to enable the radiologist to accurately read the radiology image. Each radiology workstation 14 further includes at least one user input device, such as: an illustrative computer keyboard 24; a mouse, touchpad 26, or other pointing device; a touch-sensitive display (e.g., one or both display devices 20, 22 may be a touch-screen display); a dictation microphone 28, or so forth. Optionally, the radiology workstation 14 is further capable of measuring a reading time defined between selection of a radiology examination reading task and completing receipt of the entry of the radiology report for that task with a timer (not shown) implemented by the computer 16, e.g., using the internal (i.e., system) clock of the computer.

The computer 16 is operatively connected with one or more non-transitory storage media 30 comprising a database. The non-transitory storage media 30 may, by way of non-limiting illustrative example, include one or more of a magnetic disk, RAID, or other magnetic storage medium; a solid-state drive, flash drive, electronically erasable read-only memory (EEROM) or other electronic memory; an optical disk or other optical storage; various combinations thereof; or so forth; and may be for example a network storage, an internal hard drive of the computer 16, various combinations thereof, or so forth. It is to be understood that any reference to a non-transitory medium or media 30 herein is to be broadly construed as encompassing a single medium or multiple media of the same or different types. Likewise, the computer 16 may be embodied as a single electronic processor or as two or more electronic processors. The non-transitory storage media 30 stores instructions executable by the computer 16.

The PACS 10 stores a plurality of medical images 32, can also comprise a Radiology Information System (RIS) database storing a plurality of radiology reports 34. The radiology workstation 14 is configured to provide a radiology examination reading environment configured to display images 32 of a radiology examination on the at least one display device 20, 22. For example, the computer 16 is configured to retrieve one or more images 32 from the PACS 10, and display the retrieved images 32 on the first display device 20 (which can be a high-resolution display device in order to display the images 32). In addition, a corresponding radiology report 34 for the radiology examination can entered using the at least one user input device 24, 26, 28. For example, the computer 16 is configured to retrieve a radiology report 34 from the RIS database 10 corresponding to the retrieved images 32, and display the retrieved radiology report 34 on the second display device 22. In addition, the computer 16 is configured to receive an indication the radiology report 34 (e.g., displayed on the second display device 22) is finalized via the at least one user input device 24, 26, 28.

The radiology workstation 14 is configured as disclosed herein to provide feedback to the radiologist, using multi-modality radiology data (i.e., exam information, the radiology reports 34 written by the radiologist, and the collected images 32), to prevent billing code errors due to insufficient or inaccurate documentation. The feedback may, for example, be provided as the radiologist is finalizing the report for upload to the PACS. The radiology workstation 14 also provides a way to collect feedback from the radiologist for continuous improving of a deep learning model (i.e., an AI component 38 or an AI Coder).

The AI coder 38 comprises a multi-modality radiology billing code prediction model. Inputs to the AI component 38 can include, examination info, the images 32, and the radiology reports 34. The outputs from the AI component 38 are predicted billing codes 36, along with a report completeness check result. A user input dialog 39 is displayed on the second display device 22 to display billing code and report completeness predictions in real time, and to collect feedback from the radiologist such as final billing codes selected by the radiologist which can serve as feedback to the AI coder 38 for use in update training.

A report correction generator 40 stored in the database 30 and executable by the computer 16 is configured to take the predicted or selected billing code 36, and the original radiology report 34 as input, and outputs provides report corrections 41, which can be an input to the AI component 38.

The radiology workstation 14 is configured as described above to perform a radiology examination reading support method or process 100. The non-transitory storage medium 30 stores instructions which are readable and executable by the computer 16 to perform disclosed operations including performing the radiology examination reading support method or process 100. In some examples, the method 100 may be performed at least in part by cloud processing.

Not shown in FIG. 1 is the downstream processing, during which a trained coder retrieves the stored final radiology report from the PACS 10 and assigns one or more billing codes for the radiology examination or procedure which is the subject of the report. The coder assigns the codes based on the content of the radiology report. Due to operation of the radiology examination reading support method or process 100, the likelihood is substantially increased that the radiology report contains content in a manner that facilitates accurate and efficient assigning of billing codes. For example, the radiology examination reading support method or process 100 may operate to propose alternative phrasing and/or terminology for report content that more closely aligns with clinical terms used in the CPT, ICD-10, or other billing code system, and/or may suggest including content that the radiologist may have considered clinically unnecessary, but which may be useful or even necessary to support the assignment of accurate billing codes.

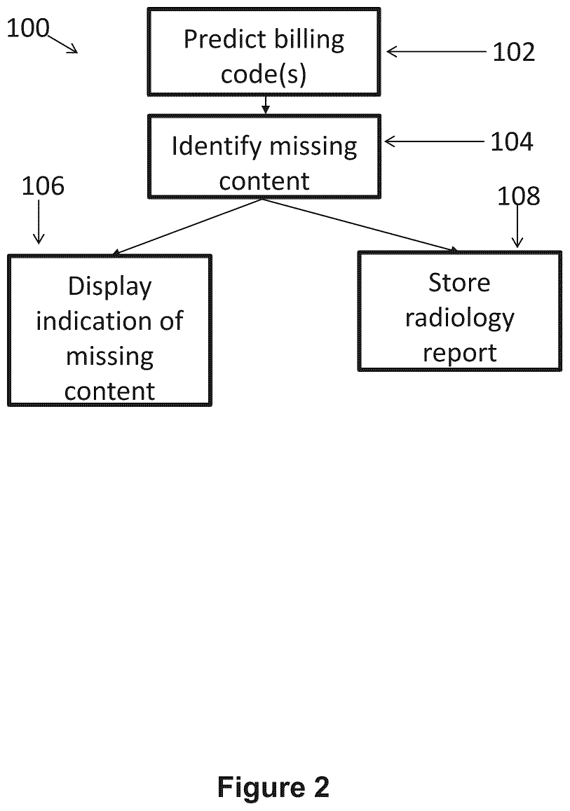

With reference to FIG. 2, and with continuing reference to FIG. 1, an illustrative embodiment of an instance of the radiology examination reading support method 100 is diagrammatically shown as a flowchart. The radiology examination reading support method 100 is commenced in response to the indication the radiology report 34 is finalized (e.g., after the images 32 and radiology report 34 are displayed).

At an operation 102, the radiology report 34 is analyzed to predict one or more billing codes 36 for the radiology examination. The billing codes 36 can be stored in the database 30. Such can be implemented by a computer 16 or processor (not shown) as radiology reports 34, generally in written form, may be processed by a trained natural language processing (NLP) operations to the elements of natural language. Consequently, the radiology workstation 14 may decompose the elements of natural language into one or more keywords that represent the actual activities carried, which can then be matched to one or more billing codes 36.

At an operation 104, the radiology report 34 is again analyzed to identify any missing (or poorly worded) content for supporting the one or more billing codes 36 that is missing from the radiology report 34. In some embodiments, a top K number of candidate billing codes 36 can be predicted, and displayed on the second display device 22 along with the radiology report 34. The radiologist can then provide a user input via the at least one user input device 24, 26, 28 related to a selection of one or more of the displayed candidate billing codes 36. The predicted one or more billing codes 36 consist of the selected one or more candidate billing codes 36.

In some embodiments, the predicting operation 104 can be performed by an artificial intelligence (AI) component 38 stored in the database 30 and executable by the computer 16. The AI component 38 is trained on historical radiology reports annotated with billing codes and annotated as to completeness with respect to the annotated billing codes. For example, the AI component 38 can comprise a Bidirectional Encoder Representations from Transformers (BERT) language model. In some embodiments, the AI component 38 is configured to score the radiology report 34 as to a degree of completeness of the radiology report 34. This scoring process can be repeated by the AI component 38 until the determined degree of completeness exceeds a predetermined threshold.

At an operation 106, in response to identifying missing content, an indication of the missing content can be displayed on the second display device 22. The indication can be, for example, an indication of one or more of the predicted billing codes 36. The computer 16 then receives an authorization from the radiologist (via the at least one user input device 24, 26, 28), and, in response, the suggested addition to the radiology report 34 is added to generate a complete radiology report 34, which can be stored in the PACS 10. At an operation 108, in response to not identifying missing content, the displayed radiology report 34 is stored in the PACS 10. Although not shown in FIG. 2, in some embodiments if revisions are made to the report in operation 106 then process flow may return to operation 102 to implement an iterative refinement of the report content, until the final accepted report is stored at operation 108.

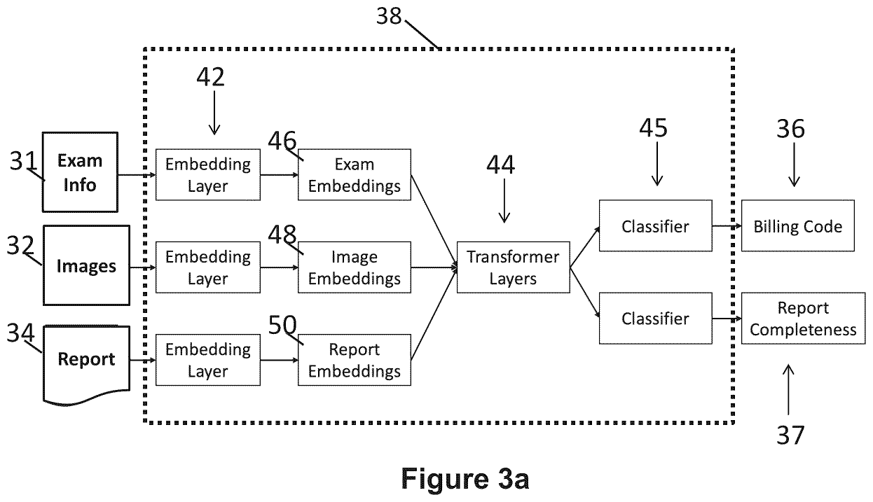

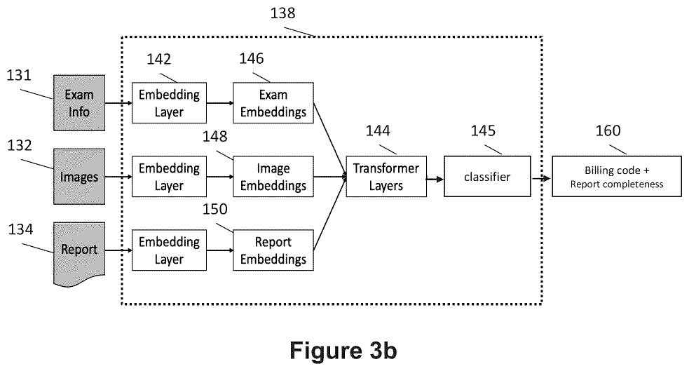

The multi-modality radiology billing code prediction model(s) (i.e., the AI component 38) is based on deep learning Natural Language Processing (NLP) techniques. One suitable architecture of the AI component 38 is shown in FIG. 3a. The AI component 38 includes embedding layers 42 and multiple transformer layers 44 with cross-modality attention. The AI component 38 takes examination information 31 in either structured or free-text format, the images 32 (e.g., X-ray, CT, ultrasound or MRI images), and the radiology report 34 as input. These inputs are converted to feature vectors/embeddings through the embedding layers (i.e., elements 46, 48, 50). For example, the embedding layers processing textual input may extract embeddings comprising words, phrases, n-grams (e.g., a 3-gram is a contiguous sequence of three words of the textual content), or so forth. The embedding layers processing image input may, for example, extract image patches, apply an artificial neural network to obtain an image embedding, and/or so forth. The embeddings 46, 48, 50 are processed by the transformer layers 44, for example using a BERT language model for processing embedded text content, a convolutional neural network (CNN) for processing embedded image content, or so forth. Classifiers 45 then classify the transformed content output by the transformer layers 44 to classify the content as to likely billing codes 36 and as to whether the report 37 is complete from a billing code assignment perspective.

The output of the AI component 38 includes: a list of pre-defined recommended billing codes 36 ranked based on their probabilities; and an indication of whether the report is complete for billing purposes (i.e., element 37). For instance, the output of the AI component 38 may consist in the determine five (5) most probably billing codes, ranked in their probabilities from the highest probability to the lowest probability. Alternatively, the system could be configured to output the two (2), three (3), or four (4), or ten (10) most probable billing codes 36, or any other number of billing codes, arranged by probability as desired.

To train the AI component 38, radiology cases (with each case containing radiology reports, images and exam information) can be used as training samples, and the corresponding confirmed billing codes 36 will be used as labels. To train the AI component 38 for checking report completeness, in one illustrative approach sections with important information for billing purposes are randomly preserved or dropped. The AI component 38 can output a “1” on the second display device 22 if the radiology report 34 is not complete and output a “0” on the second display device 22 otherwise (or some other coding can be used to denote completer versus incomplete).

During the inference phase in which the trained AI component 38 is used to assist a radiologist in finalizing a radiology report, an interface can be used to display the top-k (k is a parameter that can be selected based on users' preference) most likely billing codes 36 to the radiologist. If the radiology report 34 were found to be incomplete, an alert will be displayed on the second display device 22. To generate report corrections, a billing code 36 is selected, automatically (the predicted most likely billing code 36) or manually (radiologist selects one from the top-k most likely billing codes 36). If the radiologist decides to choose any billing code 36 from the top-k codes 36 rather than the most likely billing code 36, a feedback signal is sent to the AI component 38 for continuous improvement of the AI component 38, as diagrammatically indicated in FIG. 1.

An alternative architecture of the AI component 138 is shown in FIG. 3b. The AI component 138 includes embedding layers 142 and multiple transformer layers 144 with cross-modality attention. The AI component 138 takes examination information 131 in either structured or free-text format, the images 132 (e.g., X-ray, CT, ultrasound or MRI images), and the radiology report 134 as input. These inputs are converted to feature vectors/embeddings through the embedding layers (i.e., elements 146, 148, 150). For example, the embedding layers processing textual input may extract embeddings comprising words, phrases, n-grams (e.g., a 3-gram is a contiguous sequence of three words of the textual content), or so forth. The embedding layers processing image input may, for example, extract image patches, apply an artificial neural network to obtain an image embedding, and/or so forth. The embeddings 146, 148, 150 are processed by the transformer layers 144, for example using a BERT language model for processing embedded text content, a convolutional neural network (CNN) for processing embedded image content, or so forth. A Classifier 145 then classify the transformed content output by the transformer layers 144 to classify the content as to likely billing codes and as to whether the report is complete from a billing code assignment perspective 160.

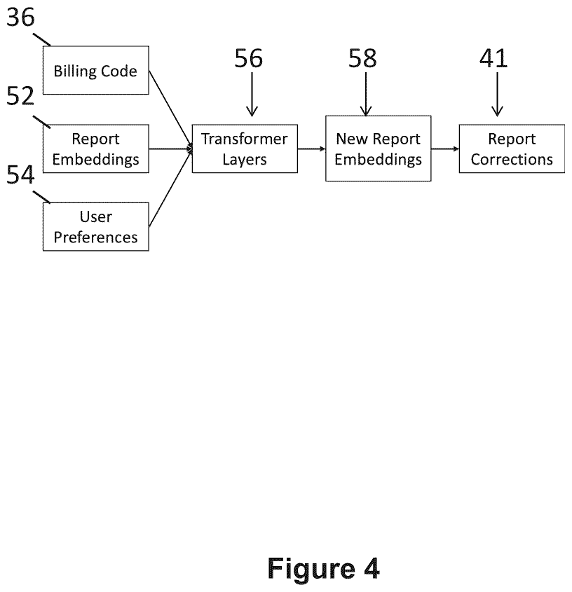

The inputs to the report correction generator 40 are the original radiology report 34 and the selected billing code 36. The outputs are predictions including the positions where changes should be made and the new words to be inserted or changed into in the radiology report 34. The architecture of the report correction generator 40 is shown in FIG. 4. To train the report correction generator 40, radiology reports 34 with corresponding billing codes 36 can be used as training samples. For a given training sample, randomly selected words (i.e., embeddings 52) from the radiology report 34 are removed or changed to a special token, and, along with user preferences 54, the report correction generator 40 recovers the changed words based on the modified report and the true billing code using one or more transformer layers 56 to generate one or more new report embeddings 58. The user can input preferences to the report correction generator 40, including the maximum number of changes allowed and sections to be excluded from modification etc., to generate the report corrections 41.

In a teleradiology setting, the distribution of the above-described components may vary. For example, the third party teleradiology service may be a different entity from both the hospital and the downstream coder (who may be a hospital employee or another third party contracting separately with the hospital to provide coding services). In this case, the availability of the input data for training the AI coder 38 and report correction generator 40 may be unavailable at the teleradiology service, since it does not have information on the final codes assigned to a report. In this situation, the at least one electronic processor performing the method of FIG. 2 may include a processor at the hospital and a processor of the radiology examination reading environment provided by the teleradiology service. The processor at the hospital (e.g., a hospital server computer) receives the radiology report from the teleradiology service and applies the method of FIG. 2 against the received teleradiology report. If missing content is detected at operation 104 then this is sent back to the teleradiology service which then performs the operation 106 of displaying the indication of the missing content. In this way, the hospital can automatically send the teleradiology report back to the teleradiology service to address any identified missing content in the report.

In another variant, if the teleradiology service is a single entity contracted by the hospital to provide both report reading and coding services, then the information for training the AI coder 38 and report correction generator 40 may be available at the teleradiology service which can then implement the method of FIG. 2 entirely at the teleradiology service (e.g., on the server of the teleradiology service using a teleradiology service PACS as the source of the training data). In this case, since the teleradiology service likely provided contracted services to a number of different client hospitals, the teleradiology service may optionally train a separate AI coder 38 and report correction generator 40 for each client hospital, so as to tailor the method of FIG. 2 for the specific coding requirements of each hospital. This can be especially useful if the hospitals are located in different regulatory jurisdictions (e.g., different countries) which may employ different medical code sets and/or coding rules.

The disclosure has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

All definitions, as defined and used herein, should be understood to control over dictionary definitions, definitions in documents incorporated by reference, and/or ordinary meanings of the defined terms.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A radiology workstation, comprising:
at least one display device;
at least one user input device; and
a processor configured to:
provide a radiology examination reading environment configured to display images of a radiology examination on the at least one display device;
receive a radiology report for the radiology examination which is entered using the at least one user input device;
analyze the radiology report to predict one or more billing codes for the radiology examination;
analyze the radiology report to identify any missing content for supporting the one or more predicted billing codes that is missing from the radiology report using an artificial intelligence (AI) component;
responsive to identifying more than one billing codes from the radiology reports, ranking such missing billing codes based on a probability; and
one of (i) in response to identifying missing content, display an indication of the missing content based on the ranking, or (ii) in response to not identifying any missing content, store the radiology report in a database.

2. The radiology workstation of claim 1, wherein the processor is further configured to, in response to identifying missing content:
displaying an indication of the one or more billing codes.

3. The radiology workstation of claim 1, wherein the processor is further configured to:
receiving an authorization to add the suggested addition via the at least one user input device and, in response, adding the suggested addition to the radiology report to generate a complete radiology report.

4. The radiology workstation of claim 1, wherein the method further includes:
predicting a top-K number of candidate billing codes presenting, on the display device, the top-K candidate billing codes; and
receiving, via the at least one user input device, an input related to a selection of one or more of the candidate billing codes, wherein the predicted one or more billing codes consist of the selected one or more candidate billing codes.

5. The radiology workstation of claim 1, wherein the predicting is performed by an artificial intelligence (AI) component trained on historical radiology reports annotated with billing codes and annotated as to completeness with respect to the annotated billing codes.

6. The radiology workstation of claim 5, wherein the AI component comprises a Bidirectional Encoder Representations from Transformers (BERT) language model.

7. The radiology workstation of claim 5, wherein the AI component further includes:
scoring the radiology report as to a degree of completeness of the radiology report.

8. The radiology workstation of claim 7, wherein determining a degree of completeness of the complete radiology report is repeated by the AI component until the determined degree of completeness exceeds a predetermined threshold.

9. A non-transitory computer readable medium storing instruction executable by at least one processor to perform a radiology examination reading support method, the method comprising:
displaying images of a radiology examination on at least one display device;
receiving a radiology report for the radiology examination which is entered using at least one user input device;
predicting one or more billing codes for the radiology examination;
predicting missing content of the radiology report for supporting the one or more billing codes that is missing from the radiology report using an artificial intelligence (AI) component;
ranking such missing billing codes based on a probability, and
one of (i) in response to identifying missing content, displaying, on the at least one display device, the missing content based on the ranking as a suggested addition to the radiology report or (ii) in response to not identifying any missing content, storing the radiology report in a database.

10. The non-transitory computer readable medium of claim 9, wherein the processor is further configured to, in response to identifying missing content:
displaying an indication of the one or more billing codes.

11. The non-transitory computer readable medium of claim 9, wherein the processor is further configured to:
receiving an authorization to add the suggested addition via the at least one user input device and, in response, adding the suggested addition to the radiology report to generate a complete radiology report.

12. The non-transitory computer readable medium of claim 9, wherein the radiology examination reading support method further comprises:
transmitting the images of the radiology examination from a hospital to a teleradiology service via the Internet, wherein the displaying of the images on the at least one display device includes displaying the images on at least one display device located at the teleradiology service and the radiology report is entered using the at least one user input device located at the teleradiology service; and
transmitting the radiology report from the teleradiology service to the hospital via the Internet.

13. The non-transitory computer readable medium of claim 10, wherein the method further includes:
predicting a top-K number of candidate billing codes;
presenting, on the display device the top-K candidate billing codes; and
receiving, via the at least one user input device, an input related to a selection of one or more of the candidate billing codes, wherein the predicted one or more billing codes consist of the selected one or more candidate billing codes.

14. The non-transitory computer readable medium of claim 9, wherein the AI component is trained on historical radiology reports annotated with billing codes and annotated as to completeness with respect to the annotated billing codes.

15. The non-transitory computer readable medium of claim 14, wherein the AI component (38) comprises a Bidirectional Encoder Representations from Transformers (BERT) language model.

16. The non-transitory computer readable medium of claim 9, wherein the AI component further includes:
scoring the radiology report as to a degree of completeness of the radiology report.

17. The non-transitory computer readable medium of claim 16, wherein determining a degree of completeness of the complete radiology report is repeated by the AI component until the determined degree of completeness exceeds a predetermined threshold.

18. A non-transitory computer readable medium storing instruction executable by at least one processor to perform a radiology examination reading support method, the method comprising:
displaying images of a radiology examination on at least one display device;
receiving a radiology report for the radiology examination which is entered using at least one user input device;
predicting one or more billing codes for the radiology examination;
predicting missing content of the radiology report for supporting the one or more billing codes that is missing from the radiology report using an artificial intelligence (AI) component; and
scoring the radiology report as to a degree of completeness of the radiology report.

19. A method for supporting radiology examination reports reading, the method comprising:
displaying images of a radiology examination on at least one display device;
receiving a radiology report for the radiology examination which is entered using at least one user input device;
predicting one or more billing codes for the radiology examination;
predicting missing content of the radiology report for supporting the one or more billing codes that is missing from the radiology report using an artificial intelligence (AI) component;
ranking such missing billing codes based on a probability, and
one of (i) in response to identifying missing content, displaying, on the at least one display device, the missing content based on the ranking as a suggested addition to the radiology report or (ii) in response to not identifying any missing content, storing the radiology report in a database.

20. A method of training an artificial intelligence (AI) component configured to predict missing content of a radiology report, the method comprising the steps of:
obtaining, from a first memory, a first dataset comprising a plurality of radiology reports, the plurality of radiology reports being labelled with billing codes, wherein the plurality of radiology reports are complete in their content for supporting one or more billing codes;
obtaining, from a second memory, a second dataset comprising metadata associated with the plurality of the radiology reports;
converting the obtained first datasets and second datasets into feature vectors;
updating the artificial intelligence (AI) component using the feature vectors;
providing the artificial intelligence (AI) component with additional radiology reports, wherein the additional radiology reports are either complete or incomplete in their content for supporting one or more billing codes; and
outputting information as to whether missing content of the radiology report for supporting the one or more billing codes is present.
